(19) United States
(12) Patent Application Publication
(10) Pub. No.: US 2021/0222791 A1
(43) Pub. Date: Jul. 22, 2021

(54) GAS/FLUID TIMER

(71) Applicants: Ronald Sopher, Haniel (IL); SOPHER AND COMPANY, Mumbai (IN)

(72) Inventor: Ronald SOPHER, Haniel (IL)

(73) Assignee: Sopher and Company, Mumbai (IN)

(21) Appl. No.: 16/093,888

(22) PCT Filed: Apr. 12, 2017
(86) PCT No.: PCT/IL2017/050446

§ 371 Date: Oct. 15, 2018

(51) Int. Cl. F16K 31/48; F16K 31/524

(52) U.S. Cl. CPC F16K 31/48; F16K 31/52491; F16K 31/485

(57) ABSTRACT

The present invention relates to systems and apparatus for controlling actuation and flow/pressure simultaneously over a timed cycle. In particular, the present invention relates to a gas/fluids actuator for readily controlling gas/fluids flow. More specifically, the present invention relates to novel improvements in timed gas/fluids flow actuation pressure/flow control and cessation thereof including: a timer including: a valve, an actuator element for controlling flow through the valve, and a timer for readily activating and deactivating the actuator.

### FIELD OF THE INVENTION

The present invention relates to systems and apparatus for controlling actuation and flow/pressure simultaneously over a timed cycle. In particular, the present invention relates to a gas/fluids actuator for readily controlling gas/fluids flow. More specifically, the present invention relates to novel improvements in timed gas/fluids flow actuation pressure/flow control and cessation thereof

### BACKGROUND OF THE INVENTION

There has long existed the need for an apparatus and system whereby a user can control the flow/pressure of gas/fluids in a controlled/timed sequence

The traditional methodology of controlling the flow of gas in a controlled/timed sequence rely on an actuator being built into the timer to activate a micro switch or a valve directly providing a simple on/off actuation at the end of the timed period. A latent deficiency of known systems and apparatus known in the art, is the need for a counteracting force against a spring loaded valve mechanism and the inlet pressure combined. Furthermore, the need for the counteracting force of a spring inherently places a limit on both the spring tension that can be used and the inlet pressure acting against the timer lever.

Other attempts to provide an efficient gas timer have required the use of complex linkages which are prone to failure and have proven to be inefficient

U.S. Pat. No. 6,797,897 describes a cam-operated timer for a household appliance featuring lanced switch arm contacts and wherein a contacting surface of at least one switch arm includes a tear in the surface of the switch arm as well as, adjacent to the tear, a first portion of the contact surface is deflected away from the surface of the switch arm in a first direction, whereby a sharp contact edge is created which permits the switch arms to make good contact with adjacent switch arms.

The invention as disclosed in U.S. Pat. No. 6,797,897 suffers from a plurality of latent deficiencies, including the reliance on switches to operate an electrical valve as well as requiring an electrical connection and an electrical actuator both subject to failure.

U.S. Pat. No. 6,992,258 describes a combination timer and controller for a gas-operated appliance, such as a pizza oven, wherein the combination includes a rotatable control shaft having a first end connectible to a gas valve and a control knob attachable to a second end of the control shaft. According to U.S. Pat. No. 6,992,258 the timer can be preset to a selected time at which the control shaft is to be turned from an off position to an on position and an actuator motor is provided to turn the control shaft to the on position and it is controlled by the timer so that the motor is turned on by the timer at the selected time as well as a gear arrangement for connecting the output of the motor to the control shaft and a coil spring for rotating the control shaft to the off position when the motor is turned off.

The invention as disclosed in U.S. Pat. No. 6,992,258 suffers from a plurality of latent deficiencies, including the need for electrical connection and motor to operate the invention disclosed as well as a high degree of complexity invariably leading to high cost and low reliability as being capable of a single operation cycle each time.

There is therefore a long felt need to provide a safety gas/fluids timer for efficiently, securely and reliably controlling the timed/controlled activation of a gas/fluids valve which readily facilitates pressure/flow control positive activation and deactivation.

Thus, it would be highly desirous to provide a safety gas/fluids timer which readily facilitates simplicity and/or ease of use as well as simplicity and/or ease of maintenance and fail safe operation.

It would be further highly desirous to provide a safety gas/fluids timer devoid of Electrical connection, motors and no Electrical contacts as well as direct cam actuation of the valve as being able to control multiple control cycles flow/pressure over the timing cycle.

### SUMMARY OF THE INVENTION

The present invention is a system and method for timed gas/fluids flow actuation and cessation and control.

### BRIEF DESCRIPTION OF THE DRAWINGS

FIG. 1 is a diagram view of a first embodiment of the system and method for timed gas/fluids flow actuation and cessation; and

FIG. 2 is a perspective view of the cam actuator according to the present invention.

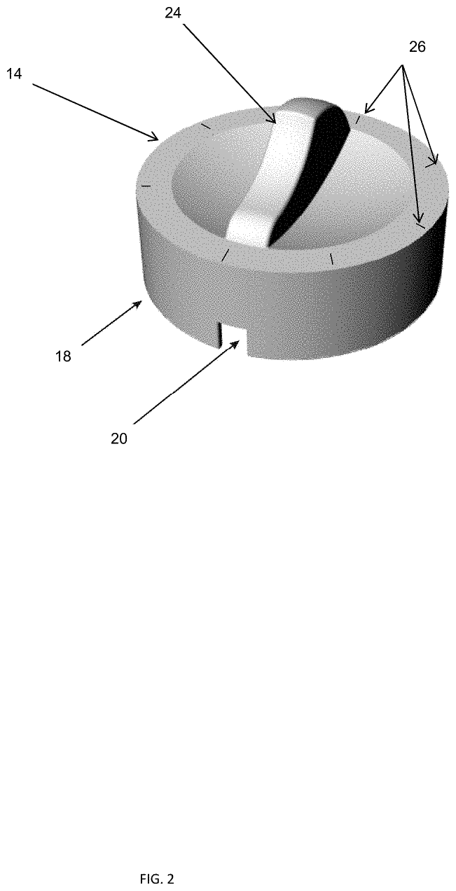

### DETAILED DESCRIPTION OF THE INVENTION

The system and method for timed gas/fluids flow control, actuation and cessation according to the present invention and as described herein, readily facilitates efficiently, securely and reliably controlling timed/controlled activation of a gas/fluids valve and which preferably shall readily facilitate simple and/or easy use as well as simple and/or easy maintenance.

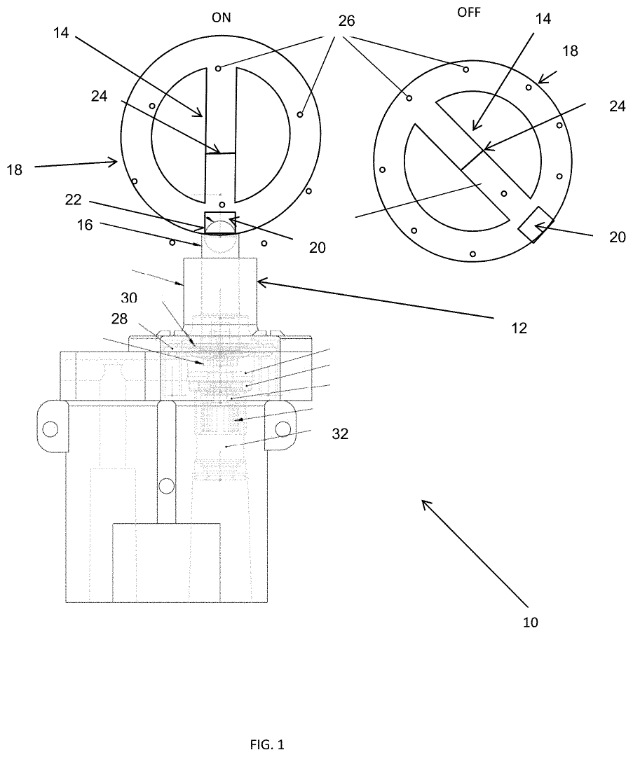

As shown in FIG. 1, a system and method for timed gas/fluids flow actuation and cessation 10 according to the present invention includes a gas/fluids valve 12, a timer 14 and an actuator element 16, attached to or integrally formed with gas/fluids valve 12 for readily activating and/or deactivating gas/fluids valve 12.

Although many other embodiments are possible within the spirit and scope of the present invention, FIG. 1 shows a non-limiting exemplary system and method for timed gas/fluids flow actuation and cessation which shows preferred methodology of the present invention and should be given the broadest reasonable interpretation.

Preferably, timer 14 is a mechanical rotateably displaceable clockwork timer including a cam surface 18. Cam surface 18 may be formed on protrusion element 24 rotated by timer 14. Cam surface 18 is tracked by plunger element 22 thereby readily controlling gas/fluids valve 12.

Preferably, cam surface 18 includes a slot/contour 20 formed in cam surface 18 for readily accommodating a plunger element 22 controlling the flow of gas/fluids through gas/fluids valve 12.

Preferably, cam surface 18 and slot 20 formed in cam surface 18 readily facilitate both ON/OFF operation as well as controlling flow over the timing cycle of gas/fluids valve 12.

Preferably, cam surface 18 includes or is integrally formed with at least one protrusion 24 for readily facilitating manual rotatable displacement of cam surface 18 by a user.

Namely, displacing cam surface 18 and actuator element 16 substantially from timer 14 to protrusion 24 and substantially spherical plunger element 22 thereby readily reducing friction between protrusion 24 and substantially spherical plunger element 22. As a person skilled in the art would envisage, the novel improvements in controlled and timed gas/fluids flow actuation and cessation of the present invention are readily usable with reducing friction between protrusion 24 and substantially spherical plunger element 22 may have other applications besides a clockwork driven timer.

Preferably, actuator element 16 and cam surface 18 can be configured to an activation selected from the group consisting of “normally open” and “normally closed”.

Preferably, cam surface 18 can be configured to include a multiplicity of slots 20 for readily facilitating sequence operation of gas/fluids valve 12.

Preferably, cam surface 18 includes a plurality of time markings 26 for readily setting actuator element for a timed activation.

Optionally, gas/fluids valve 12 is readily activated by rotateably displacing protrusion 24 and cam surface 18 wherein, according the non-limiting example herein is preferably “normally off”.

Preferably, gas/fluids valve 12 includes a diaphragm 28 and a seal 30 for the purpose of substantially resolving a diaphragm failure leading to inadvertent gas/fluids flow.

Preferably, displacement of cam surface 18 and tracking cam surface 18 with substantially spherical plunger element 22 readily provides several distinct advantages over gas flow timers known in the art, including but not limited to the torque required to actuate the gas/fluids valve 12 is reduced, cam surface 18 diameter is determined by protrusion element 24, multiple slots 20 can be readily formed thereby readily facilitating a plurality of activations and cessations of flow and pressure control in a single rotation and thus gas/fluids valve 12 is not limited to a simple ON/OFF actuation and control of gas/fluids valve 12 is not restricted to a “start” and an “end” of a rotation.

Preferably, diaphragm 28 is a nitrile or neoprene valve diaphragm for readily regulating gas/fluids flow there through by way of activating a gas/fluids valve.

Preferably, plunger element 22 is substantially spherical and rotationally displaceable for readily reducing friction in contact with cam surface 18.

Optionally, plunger element 22 is substantially cylindrical and readily rotationally displaceable for readily reducing friction in contact with cam surface 18.

Preferably, plunger element 22 is biased with a bias 32 for readily facilitating positive “off action” for high pressure and low pressure.

Preferably, cam surface 18 and plunger element 22 by way of actuating through slot 20 substantially reduce friction and readily facilitate use of an increased resilient bias 32 thereby providing enhanced sealing properties at both low and high pressures.

As can be seen in FIG. 1 and as a person skilled in the art would envisage, the novel improvements in controlled and timed gas/fluids flow actuation and cessation of the present invention are readily usable with the flow of liquids and fluids and not only gas.

The use of actuator element 16 and/or protrusion 24 and/or cam surface 18 with slot 20 readily facilitate at least one task selected from the group consisting of: a control of flow rate, at least one complex control sequence using a plurality of cam surfaces 18 controlling a single valve and a control of more than one valve sequence using a plurality of cams surfaces and/or valves. As such, the use of actuator element 16 and/or protrusion 24 and/or cam surface 18 with slot 20 readily facilitate replacing linkages known in the art and providing a positive on/off mechanism. Furthermore, the construction of the gas/fluids timer according to the present invention readily facilitates sequencing operation a plurality of gas/fluids valves 12 over a 24 hour period as well as complex timed sequencing, pressure and flow control.

It will be appreciated that the above descriptions are intended to only serve as examples, and that many other embodiments are possible within the spirit and scope of the present invention.

What is claimed is:

1. A timer comprising:
(a) a valve;
(b) an actuator element for controlling flow through said valve; and
(c) a timer for readily activating and deactivating said actuator.

2. The timer of claim 1, wherein said valve is a gas valve.

3. The timer of claim 1, wherein said valve is a fluid/liquid valve.

4. The timer of claim 1, wherein said timer is a mechanical clockwork timer.

5. The timer of claim 1, wherein said timer further comprises a cam surface and wherein said cam surface further includes a slot formed in said cam surface for readily accommodating a plunger element controlling flow through said valve.

6. The timer of claim 1, wherein said valve includes a diaphragm and a seal for substantially resolving a diaphragm failure leading to inadvertent flow.

7. The timer of claim 1, wherein said actuator element further comprises a protrusion for readily facilitating manual rotatable displacement of said actuator element.

8. The timer of claim 5, wherein said plunger element plunger element is substantially spherical for readily reducing friction in contact with said cam surface and wherein said plunger is biased with a bias for readily facilitating positive “off action” for high pressure and low pressure.

9. The timer of claim 2, wherein said timer further comprises including a cam surface and wherein said cam surface further includes a slot formed in said cam surface for readily accommodating a plunger element controlling flow/pressure through said gas valve.

10. The timer of claim 9, wherein said gas valve includes a diaphragm and a seal for substantially resolving a diaphragm failure leading to inadvertent gas flow.

11. The timer of claim 9, wherein said timer further comprises a cam surface and wherein said cam surface further includes a slot formed in said cam surface for readily accommodating a plunger element controlling flow through said valve and wherein said cam surface includes a protrusion for readily facilitating manual rotatable displacement of said cam surface

12. The timer of claim 9, wherein said plunger element plunger element is substantially spherical for readily reducing friction in contact with said cam surface and wherein said plunger is biased with a bias for readily facilitating positive “off action” for high pressure and low pressure.

13. The timer of claim 3, wherein said timer further comprises including a cam surface and wherein said cam surface further includes a slot formed in said cam surface for readily accommodating a plunger element controlling flow through said fluid/liquid valve.

14. The timer of claim 13, wherein said fluid/liquid valve includes a diaphragm and a seal for substantially resolving a diaphragm failure leading to inadvertent fluid/liquid flow.

15. The timer of claim 13, wherein said actuator element further comprises a protrusion for readily facilitating manual rotatable displacement of said actuator element.

16. The timer of claim 13, wherein said plunger element is substantially spherical for readily reducing friction in contact with said cam surface and wherein said plunger is biased with a bias for readily facilitating positive “off action” for high pressure and low pressure.

17. The timer of claim 13, wherein said timer further comprises including a variable cam surface and wherein said cam surface further is tracked by a plunger element which in addition can also control the amount of flow/pressure through said gas/fluid/liquid valve.

18. The timer of claim 1, wherein said timer further comprises including a cam surface and wherein said cam surface further includes a contour formed in said cam surface for readily accommodating a plunger element controlling flow through said valve.

19. The timer of claim 5, wherein said plunger element plunger element is substantially spherical for readily reducing friction in contact with said cam surface and wherein said plunger is biased with a bias for readily facilitating positive “off action” for precise control of pressure/flow.

20. The timer of claim 9, wherein said plunger element plunger element is substantially spherical for readily reducing friction in contact with said cam surface and wherein said plunger is biased with a bias for readily facilitating flow/pressure control.
